(19) United States
(12) Patent Application Publication
(10) Pub. No.: US 2004/0006577 A1
(43) Pub. Date: Jan. 8, 2004

(54) Method for managing media files

(76) Inventor: Malcolm Rix, Taipei (TW)

Correspondence Address: BIRCH STEWART KOLASCH & BIRCH, PO BOX 747, FALLS CHURCH, VA, 22040-0747, US

(21) Appl. No.: 10/186,672

(22) Filed: Jul. 2, 2002

(51) Int. Cl. G06F 17/30

(52) U.S. Cl. 707/200

(57) ABSTRACT

A method for managing media files. The method comprises the steps of storing a plurality of rating tags, receiving a first command, linking the rating tags to the media files according to the first command, receiving a second command, and processing the media files linked to the same rating tag according to the second command.

### BACKGROUND OF THE INVENTION

1. Field of the Invention

The present invention relates to a method for managing media files, particularly to a method, for rating the media files.

2. Description of the Prior Art

It is common to store digital photographs and video clips in files on computers. In many applications the images or videos do not have meaningful filenames or useful textual metadata that can be used to select groups of files. Instead, media browsing programs are used to locate the desired items visually.

Digital still cameras and digital video cameras allow users to take large numbers of photographs since the cost of each shot is very low. Users tend to organize the images or videos into folders according to date taken, project or subject. It is known that users are disinclined to delete many original images or videos unless they have serious technical faults. Most are retained ostensibly to form a historical record or because selection criteria may change at a future date.

In many viewing situations users may only want to show or use some of the best material, due to limitations of time or output media space. In most file systems, sets of files can be selected although making these selections is time consuming. When the selections have been made, there are ways of retaining the selections for future use. Some are:

Renaming—Selected files can be renamed, but this tends to disrupt sorting order of files.

Albums—Selected files can be referenced from databases. This tends to lead to file system/database synchronization issues. Sets are difficult to maintain during backup.

Separate folders—Selected files can be placed in different folders. This tends to complicate image management and can lead to duplication and wasted storage capacity.

All the previously described methods conflict with the management of media within the file system or make it more difficult.

### SUMMARY OF THE INVENTION

Therefore, the object of the present invention is to provide a method for managing media files. By linking rating tags to the media files, the invention makes it convenient for users to select interesting groups of media files and does not conflict with the management of media within the file system.

The present invention provides a method for managing media files comprising the steps of storing a plurality of rating tags, receiving a first command, linking the rating tags to the media files according to the first command, receiving a second command, and processing the media files linked to the same rating tag according to the second command.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 is a diagram showing a GUI according to one embodiment of the invention.

FIG. 2. is a flowchart of a method for managing media files according to an embodiment of the invention.

### DETAILED DESCRIPTION OF THE INVENTION

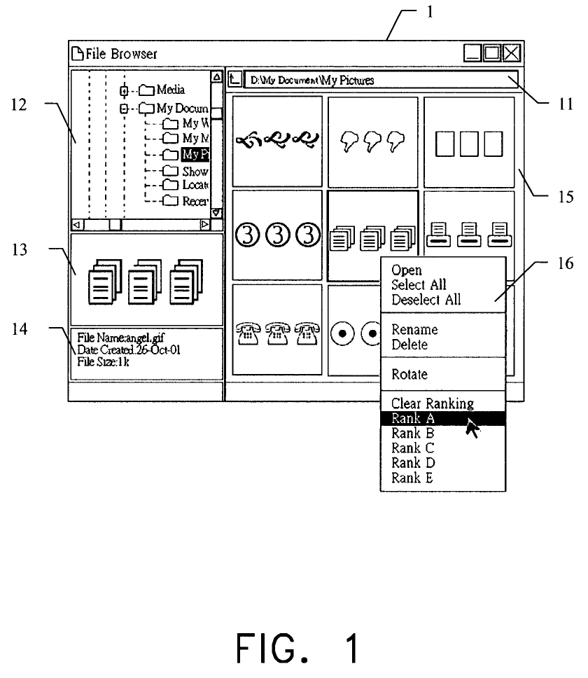

The invention can be applied to media files such as images, sounds, videos or albums (containing a sequence or collection of images, sounds or videos) and is preferably practiced in the context of image browser software. In these programs, media files are displayed as thumbnails or slideshows. FIG. 1 is a diagram showing a GUI (Graphic User Interface) according to one embodiment of the invention. The GUI comprises a main window 1, areas 11˜15, and a popup menu 16. The path of the selected folder is shown in the area 11. The file structure is graphically shown in the area 12. A preview of the selected image is shown in the area 13. File information of the selected image is shown in the area 14. All the thumbnails of the images in the selected folder are shown in the area 15. When a user selects an image, the menu 16 appears. The rating tag A, for example, is linked to the selected image by clicking “Rank A” in the menu 16. The rating tags linked to the selected image can be removed by clicking “Clear Ranking” in the menu 16. The rating tag linked to the selected image can be stored within the image files themselves, such as in a JPEG APP block or as XML metadata records. Alternatively, they can be stored in a centralized metadata database, or stored in a file in a folder where the media files are stored.

In the invention, a simple alpha-numeric rating tag such as A, B, C or 1, 2, 3 is applied to each individual media file. The rating can be used to segment the best material, or to select material on different subjects. The rating can be readily recalled or displayed. The rating can be used as search criteria in subsequent search or find tasks. The rating can be used to select subsets of the images for subsequent processing, display, or communication. Images with different rating tags may be processed differently. Since the ratings are independent from the storage system, images can be copied, stored, modified or renamed without ratings being accidentally lost.

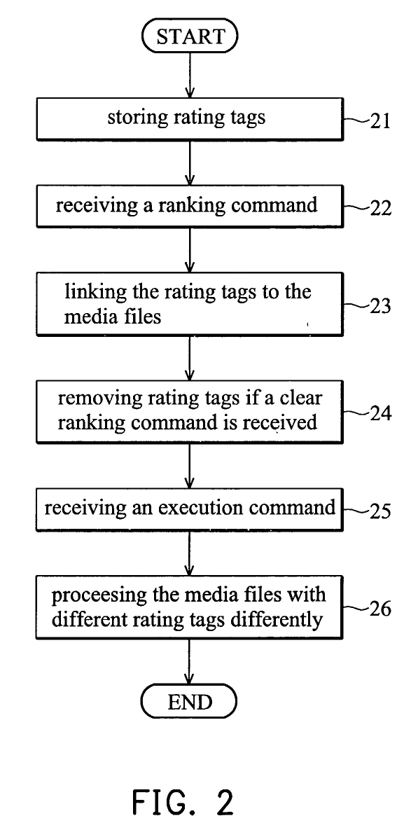

FIG. 2. is a flowchart of a method for managing media files according to one embodiment of the invention.

In step 21, a plurality of rating tags such as A, B, C, D and E are stored.

In step 22, a ranking command from a user is received.

In step 23, the rating tags are linked to media files, such as images, according to the ranking command.

In step 24, if a clear ranking command is received, the rating tags are removed from the linked images.

In step 25, an execution command from the user is received.

In step 26, the images linked to the same rating tag are processed according to the user's execution command. The images linked to a first rating tag, such as A, are printed larger than the images linked to a second rating tag, such as B, when the execution command is to print the images in different sizes according to their rating tags. The images linked to the rating tag A are made lighter than the images linked to the rating tag B when the execution command is to make a brightness difference between the images with tags A and B. The images linked to the rating tag A are viewed for more time than the images linked to the rating tag B when the images are viewed as slide shows according to the user's execution command. The images linked to the same rating tag are moved into a folder when the user selects one group of the images with the same tag and moves them into the folder.

The rating tags linked to the images also can be shown when the user is viewing the images. The rating tags can be a searching criteria when the user only want to find out the images linked to a same rating tag.

In conclusion, by linking rating tags to the media files, it is convenient for users to select interesting groups of the media files and does not conflict with the management of media within the file system. The media files with different rating tags may be processed differently.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for managing media files comprising the steps of:
storing a plurality of rating tags;
receiving a first command;
linking the rating tags to the media files according to the first command;
receiving a second command; and
processing the media files linked to the same rating tag according to the second command.

2. The method as claimed in claim 1, wherein the media files are images.

3. The method as claimed in claim 1, wherein the media files are videos.

4. The method as claimed in claim 1, wherein the media files are sounds.

5. The method as claimed in claim 1, wherein the media files are albums.

6. The method as claimed in claim 2, wherein the processing step is to print the images linked to a first rating tag larger than the images linked to a second rating tag according to the second command.

7. The method as claimed in claim 2, wherein the processing step is to make the images linked to a first rating tag lighter than the images linked to a second rating tag according to the second command.

8. The method as claimed in claim 2, wherein the processing step is to view the images linked to a first rating tag for longer than the images linked to a second rating tag according to the second command.

9. The method as claimed in claim 2, wherein the processing step is to move the images linked to the same rating tag into a folder according to the second command.

10. The method as claimed in claim 1 further comprising the step of:
displaying the media files in thumbnails and the rating tags linked thereto.

11. The method as claimed in claim 1 further comprising the steps of
receiving a third command; and
removing the rating tags from the linked media files.

12. The method as claimed in claim 1 further comprising the step of:
searching the media files linked to the same rating tag.

13. The method as claimed in claim 1, wherein the rating tags are stored within the linked media files.

14. The method as claimed in claim 1, wherein the rating tags are stored in a file in a folder where the media files are stored.
